(19) United States
(12) Patent Application Publication
(10) Pub. No.: US 2015/0242780 A1
(43) Pub. Date: Aug. 27, 2015

(54) AUTOMATED RECOMMENDATION ENGINE FOR HUMAN RESOURCE MANAGEMENT

(71) Applicant: Gregory J. Besner, Short Hills, NJ (US)

(72) Inventor: Gregory J. Besner, Short Hills, NJ (US)

(21) Appl. No.: 14/631,303

(22) Filed: Feb. 25, 2015

Related U.S. Application Data
(60) Provisional application No. 61/944,703, filed on Feb. 26, 2014.

(51) Int. Cl. G06Q 10/06; G06Q 10/10

(52) U.S. Cl. CPC G06Q 10/0637; G06Q 10/105

(57) ABSTRACT

Technologies for automated human resources management include a human resources server, a number of administrator computing devices, and a number of employee computing devices. The human resources server collects survey data on corporate culture from the employee computing devices, analyzes the survey data, and recommends one or more initiatives to improve corporate culture. The recommendation may be based on predefined ideas for improvement, prior results recorded by other organizations, or suggestions from employees. The administrator computing devices may access the survey data and recommendations. The human resources server receives results data associated with initiatives implemented by a client organization, and optimizes future recommendations based on the results data. The human resources server may connect the client organization with one or more partner organizations to implement the recommendations. The human resources server may solicit feedback on prior initiatives from employee computing devices. Other embodiments are described and claimed.

### CROSS-REFERENCE TO RELATED APPLICATION

The present application claims priority under 35 U.S.C. §119(e) to U.S. Provisional Patent Application Ser. No. 61/944,703, entitled “AUTOMATED RECOMMENDATION ENGINE FOR HUMAN RESOURCE MANAGEMENT,” which was filed on Feb. 26, 2014, which is expressly incorporated herein by reference.

### BACKGROUND

Organizations such as corporations, nonprofits, and governments typically exhibit a distinct corporate or organizational culture. Aspects of corporate culture include corporate norms, values, and behaviors of employees. Negative corporate culture or negative aspects of corporate culture may cause increased employee turnover, reduced employee productivity, or reduced employee engagement. Thus, human resources departments at many organizations may attempt to improve aspects of corporate culture. Attempts at improving culture by human resources departments and/or consultants may be based on intuition or anecdotal data.

Typical computing systems may allow a human resources department to generate surveys that may be completed by employees. Such typical systems may allow the human resources department to perform limited analysis on survey results or compare survey results to benchmarks.

### SUMMARY

According to one aspect of the present disclosure, a method for corporate culture improvement includes collecting, by a human resources server, corporate culture survey data from one or more employee computing devices; analyzing, by the human resources server, the survey data; recommending, by the human resources server, an initiative to improve corporate culture as a function of the survey data using a recommendation engine of the human resources server; receiving, by the human resources server, results data associated with the recommended initiative; and optimizing, by the human resources server, the recommendation engine as a function of the results data.

In some embodiments, the method may further include transmitting, by the human resources server, an invitation to provide survey data to one or more employees; and requesting, by the human resources server, the results data associated with the recommended initiative in the invitation to provide survey data. Receiving the results data includes receiving the results data from the employee computing device in response to transmitting the invitation.

In some embodiments, the method further includes receiving, by the human resources server, the initiative from an employee computing device.

In some embodiments, the analyzing the survey data includes generating a composite culture score as a function of the survey data. Generating the composite culture score may include generating a composite culture score as a function of a category of the survey data.

In some embodiments, the method further includes receiving, by the human resources server, one or more parameters associated with the recommended initiative; and associating, by the human resources server, the results data with the one or more parameters.

In some embodiments, the method further includes registering, by the human resources server, a client organization associated with the survey data with a partner organization to implement the recommended initiative.

In some embodiments, collecting the survey data includes collecting the survey data associated with a first client organization; receiving the results data includes receiving the results data associated with the recommended initiative from a second client organization; and recommending the initiative includes recommending the initiative as a function of the results data received from the second client organization. The method may further include collecting, by the human resources server, first organization data associated with the first client organization; and collecting, by the human resources server, second organization data associated with the second client organization. Recommending the initiative may include recommending the initiative as a function of the first organization data and the second organization data. An attribute of the first organization data may match the attribute of the second organization data, the attribute being one of geographical location, organization size, organization field, or organization industry.

According to another aspect of the present disclosure, a human resources server for corporate culture improvement includes a survey module, an analytics module, a recommendation engine module, and an implementation module. The survey module is to collect corporate culture survey data from one or more employee computing devices. The analytics module is to analyze the survey data. The recommendation engine is module to recommend an initiative to improve corporate culture as a function of the survey data using a recommendation engine of the human resources server. The implementation module is to receive results data associated with the recommended initiative and optimize the recommendation engine as a function of the results data.

In some embodiments, the implementation module is further to receive one or more parameters associated with the recommended initiative; and associate the results data with the one or more parameters.

In some embodiments, the implementation module is further to register a client organization associated with the survey data with a partner organization to implement the recommended initiative.

In some embodiments, to collect the survey data includes to collect the survey data associated with a first client organization; to receive the results data includes to receive the results data associated with the recommended initiative from a second client organization; and to recommend the initiative includes to recommend the initiative as a function of the results data received from the second client organization.

In some embodiments, the survey module is further to collect first organization data associated with the first client organization, and collect second organization data associated with the second client organization. To recommend the initiative includes to recommend the initiative as a function of the first organization data and the second organization data, wherein an attribute of the first organization data matches the attribute of the second organization data, the attribute being one of geographical location, organization size, organization field, or organization industry.

According to another aspect of the present disclosure, one or more computer-readable storage media include a plurality of instructions that in response to being executed cause a human resources server to collect corporate culture survey data from one or more employee computing devices; analyze the survey data; recommend an initiative to improve corporate culture as a function of the survey data using a recommendation engine of the human resources server; receive results data associated with the recommended initiative; and optimize the recommendation engine as a function of the results data.

In some embodiments, the one or more computer-readable storage media further include a plurality of instructions that in response to being executed cause the human resources server to receive one or more parameters associated with the recommended initiative; and associate the results data with the one or more parameters.

In some embodiments, the one or more computer-readable storage media further include a plurality of instructions that in response to being executed cause the human resources server to register a client organization associated with the survey data with a partner organization to implement the recommended initiative.

In some embodiments, to collect the survey data includes to collect the survey data associated with a first client organization; to receive the results data includes to receive the results data associated with the recommended initiative from a second client organization; and to recommend the initiative includes to recommend the initiative as a function of the results data received from the second client organization.

In some embodiments, the one or more computer-readable storage media further include a plurality of instructions that in response to being executed cause the human resources server to collect first organization data associated with the first client organization; and collect second organization data associated with the second client organization. To recommend the initiative includes to recommend the initiative as a function of the first organization data and the second organization data, wherein an attribute of the first organization data matches the attribute of the second organization data, the attribute being one of geographical location, organization size, organization field, or organization industry.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for automated human resource analytics and improvement;

FIG. 2 is a simplified block diagram of at least one embodiment of an environment that may be established by a human resources server of the system of FIG. 1;

FIG. 3 is a high-level diagram of at least one embodiment of a methodology for automated human resource analytics and improvement that may be implemented using the system of FIGS. 1 and 2;

FIG. 4 is a simplified flow diagram of at least one embodiment of a method for automated human resource analytics and improvement that may be executed by the human resources server of FIGS. 1 and 2;

FIG. 5 is an illustration of at least one embodiment of an initial survey message of the system of FIGS. 1 and 2;

FIGS. 6 and 7 are each illustrations of at least embodiment of a user interface for survey data collection of the system of FIGS. 1 and 2;

FIGS. 8-10 are each illustrations of at least one embodiment of a user interface for survey data analytics of the system of FIGS. 1 and 2;

FIGS. 11 and 12 are each illustrations of at least one embodiment of a user interface for a recommendation engine of the system of FIGS. 1 and 2; and

FIG. 13 is a simplified flow diagram of at least one embodiment of a method for generating recommended initiatives for improving corporate culture that may be executed by the system of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

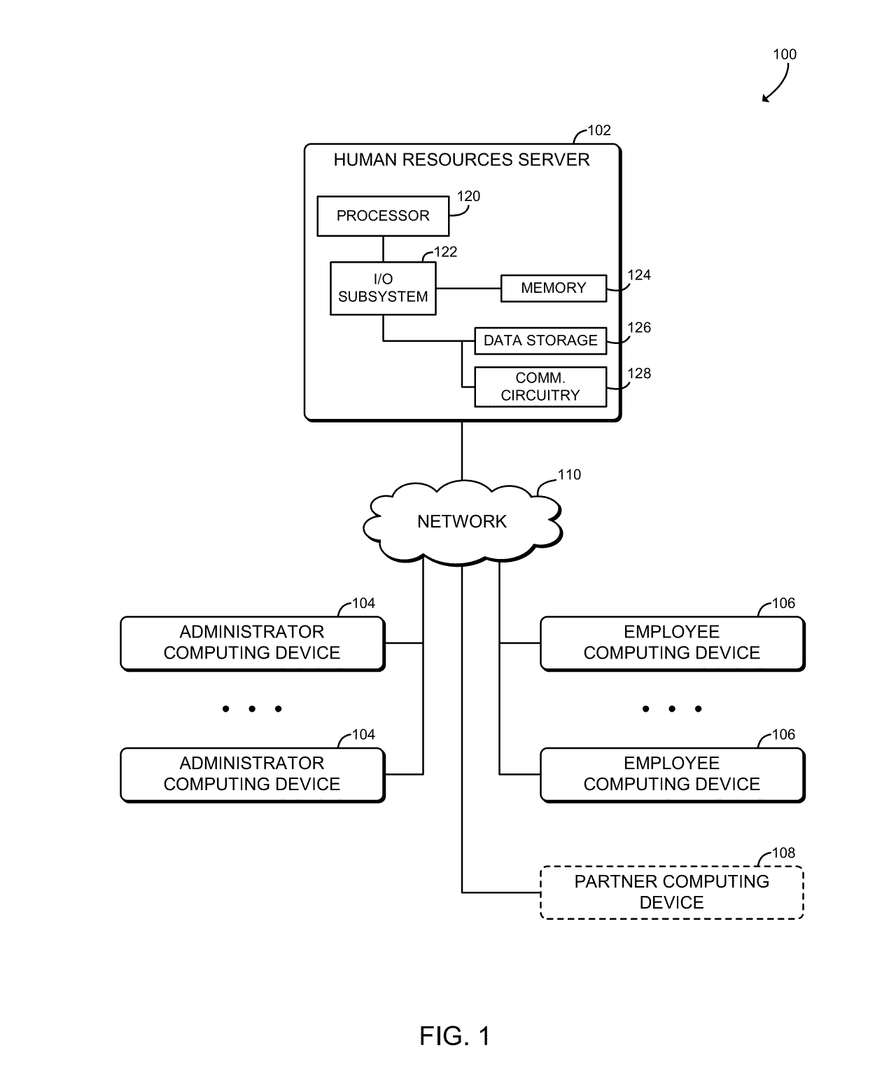

Referring now to FIG. 1, in the illustrative embodiment, a system 100 for automated human resource analytics and improvement includes a human resources server 102, a number of administrator computing devices 104, and a number of employee computing devices 106, all capable of communication with each other over a network 110. In use, as described below, the human resources server 102 collects survey data from the employee computing devices 106 concerning the corporate culture of one or more client organizations (such as businesses, governments, non-profits, or other entities). The human resources server 102 analyzes the survey data, and administrators of each client organization (such as executives, human resources professionals, or other individuals) may access the analyzed survey data using the administrator computing devices 104. Additionally, the human resources server 102 may generate one or more recommended ideas for improving corporate culture of each client organization based on the survey data. The human resources server 102 collects feedback from the administrator computing devices 104 and/or the employee computing devices 106 concerning the particular ideas implemented at the client organization, as well as the results associated with implemented ideas. The recommendation engine is refined based on the measured feedback. Additionally, in some embodiments, the human resources server 102 may communicate with one or more partner computing devices 108 to assist the client organization in implementing the recommended ideas.

Thus, by adjusting the recommendation engine based on measured results, the system 100 may provide data-driven recommendations for improving corporate culture. Additionally, the system 100 may improve the recommendation engine using results associated with ideas implemented by numerous, diverse client organizations. Thus, the ideas recommended by the system 100 may provide better results than anecdotal recommendations or recommendations based on more-limited experience. Accordingly, the system 100 may improve employee engagement as well as increase employee productivity and/or retention for the client organization.

The human resources server 102 may be embodied as any type of device for collecting survey information and generating recommendations as described herein. For example, the human resources server 102 may be embodied as, without limitation, a server computer, a workstation, a desktop computer, a mobile computing device, a distributed computing system, a multiprocessor system, a consumer electronic device, and/or any other computing device configured to perform the functions described herein. Further, the human resources server 102 may be embodied as a single server computing device or a collection of servers and associated devices. For example, in some embodiments, the human resources server 102 is embodied as a cloud service to perform the functions described herein. In such embodiments, the human resources server 102 may be embodied as a “virtual server” formed from multiple computing devices distributed across the network 110 and operating in a public or private cloud. Accordingly, although the human resources server 102 is illustrated in FIG. 1 and described below as embodied as single server computing device, it should be appreciated that the human resources server 102 may be embodied as multiple devices cooperating together to facilitate the functionality described below.

As shown in FIG. 1, the illustrative human resources server 102 includes a processor 120, an input/output subsystem 122, a memory 124, and a data storage device 126. Of course, the human resources server 102 may include other or additional components, such as those commonly found in a server and/or a stationary computer (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the human resources server 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the human resources server 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processor 120, the memory 124, and other components of the human resources server 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The data storage device 126 may store survey data, recommended ideas, results of implemented ideas, or other data used by the system 100. In some embodiments, the data storage device 126 may be embodied as distributed data storage including, without limitation, network-attached storage, a storage-area-network, a database server, or other distributed data storage devices.

The human resources server 102 further includes a communication circuit 128, which may be embodied as any communication circuit, device, or collection thereof, capable of enabling communications between the human resources server 102, the administrator computing devices 104, the employee computing devices 106, and/or other remote devices. The communication circuit 128 may be configured to use any one or more communication technology (e.g., wireless or wired communications) and associated protocols (e.g., Ethernet, Bluetooth®, Wi-Fi®, WiMAX, etc.) to effect such communication. The communication circuit 128 may be embodied as a network adapter, including a wireless network adapter.

Each administrator computing device 104 may be embodied as any type of device for performing the functions described herein, including executing a web browser, mail client, or other client software for accessing the human resources server 102. For example, each administrator computing device 104 may be embodied as, without limitation, a desktop computer, a workstation, a laptop computer, a notebook computer, a mobile computing device, a smart phone, a tablet computer, a wearable computing device, a cellular telephone, a handset, a messaging device, a vehicle telematics device, a server computer, a distributed computing system, a multiprocessor system, a consumer electronic device, and/or any other computing device configured to perform the functions described herein. As such, each administrator computing device 104 may include components and features similar to the human resources server 102, such as a processor, I/O subsystem, memory, data storage, communication circuitry, and various peripheral devices, which are not illustrated in FIG. 1 for clarity of the present description.

Similarly, each employee computing device 106 may be embodied as any type of device for performing the functions described herein, including executing a web browser, mail client, or other client software for accessing the human resources server 102. For example, each employee computing device 106 may be embodied as, without limitation, a desktop computer, a workstation, a laptop computer, a notebook computer, a mobile computing device, a smart phone, a tablet computer, a wearable computing device, a cellular telephone, a handset, a messaging device, a vehicle telematics device, a server computer, a distributed computing system, a multiprocessor system, a consumer electronic device, and/or any other computing device configured to perform the functions described herein. As such, each employee computing device 106 may include components and features similar to the human resources server 102, such as a processor, I/O subsystem, memory, data storage, communication circuitry, and various peripheral devices, which are not illustrated in FIG. 1 for clarity of the present description. Further, it should be understood that although the administrator computing devices 104 and the employee computing devices 106 are illustrated as distinct devices, in some embodiments those devices may be identical, shared, combined, or otherwise interchangeable. For example, in some embodiments a single workstation may be capable of performing the functions of both an administrator computing device 104 and an employee computing device 106. In that embodiment, the function of that workstation may be determined by the credentials of the current user, the current address of a web browser, a currently executing database application, or otherwise determined at runtime.

Last, the partner computing device 108 may be embodied as any type of device for performing the functions described herein. For example, the partner computing device 108 may be embodied as, without limitation, a server computer, a workstation, a desktop computer, a laptop computer, a notebook computer, a mobile computing device, a smart phone, a tablet computer, a wearable computing device, a cellular telephone, a handset, a messaging device, a vehicle telematics device, a server computer, a distributed computing system, a multiprocessor system, a consumer electronic device, and/or any other computing device configured to perform the functions described herein. As such, the partner computing device 108 may include components and features similar to the human resources server 102, such as a processor, I/O subsystem, memory, data storage, communication circuitry, and various peripheral devices, which are not illustrated in FIG. 1 for clarity of the present description. Further, although the system 100 is illustrated as including a single, optional partner computing device 108, it should be understood that in other embodiments the system 100 may include any number of partner computing devices 108.

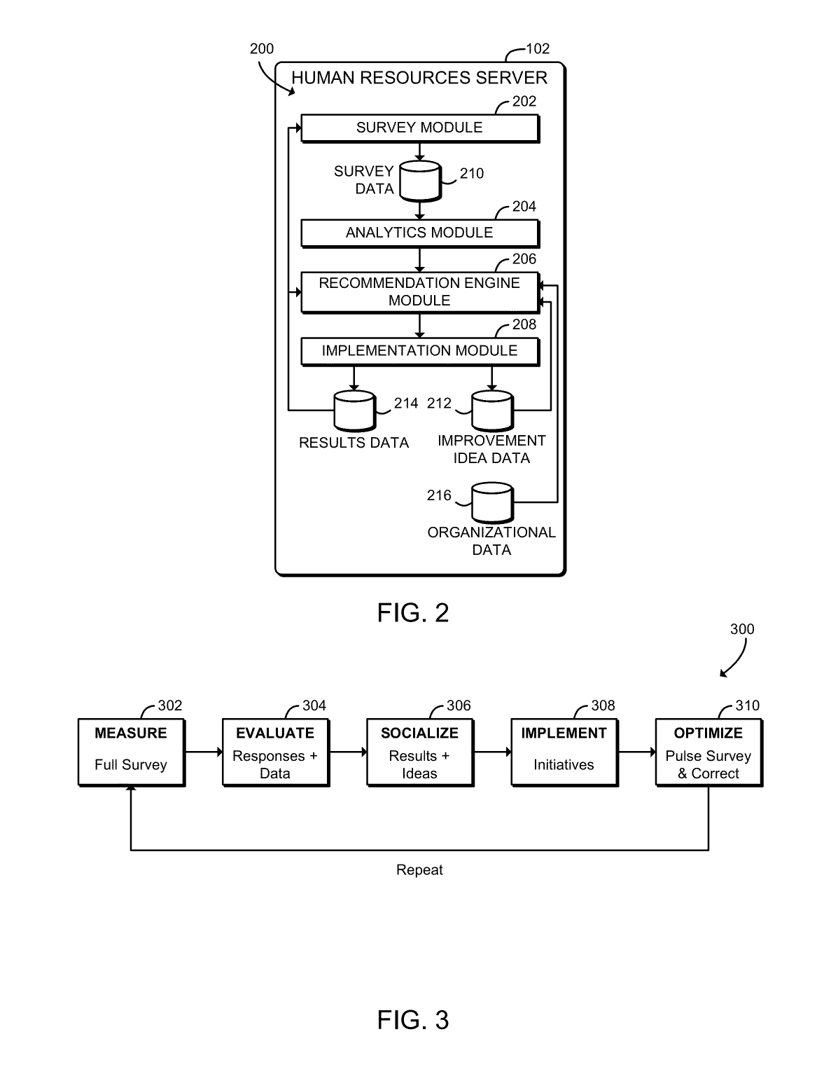

Referring now to FIG. 2, in some embodiments the human resources server 102 establishes an environment 200 during operation. The illustrative environment 200 includes a survey module 202, an analytics module 204, a recommendation engine module 206, and an implementation module 208. The various modules of the environment 200 may be embodied as hardware, firmware, software, or a combination thereof.

The survey module 202 is configured to collect survey data 210 from one or more employee computing devices 106. To do so, the survey module 202 may transmit an invitation message such as an email to employees, and establish a data input interface such as a website to receive the survey data 210. The survey module 202 may also request feedback on prior initiatives from employees. The survey data 210 may include responses received from employees to various questions designed to quantify corporate culture of each client organization.

The analytics module 204 is configured to analyze the survey data 210. The analytics module 204 may identify aspects of corporate culture that may be improved based on the survey data 210, identify trends within the survey data 210, summarize and/or aggregate the survey data 210, or provide any other appropriate data analysis of the survey data 210. The analytics module 204 may make the results of the analysis available to one or more administrator computing devices 104, for example through a website or a database interface.

The recommendation engine module 206 is configured to recommend one or more ideas to improve corporate culture based on the survey data 210 and the analysis performed by the analytics module 204. The recommendation engine module 206 may select the ideas for improvement from improvement idea data 212. As described further below, the improvement idea data 212 may include predefined ideas, ideas previously implemented by the client organization or other organizations, or ideas suggested by employees. As also described further below, the recommendation engine module 206 may further select the ideas for improvement based on results data 214 and/or organizational data 216. The recommendation engine module 206 may make the recommended ideas available to the administrator computing devices 104, for example through a website or database interface.

The implementation module 208 is configured to receive and manage results data 214 associated with one or more ideas for improvement that are implemented by a client organization. Ideas for improvement that are implemented by the client organization are also called initiatives. The results data 214 may include administrator and employee feedback on the success, failure, or other outcome associated with particular initiatives. The implementation module 208 is also configured to optimize the recommendation engine module 206 based on the results data 214 and/or the organization data 216. For example, the implementation module 208 may make results data 214 available to the recommendation engine module 206, which may allow the recommendation engine module 206 to recommend ideas associated with better outcomes. Additionally, in some embodiments the implementation module 208 is configured to allow the client organization to identify, purchase, register, or otherwise connect with a partner to assist in implementing the recommended idea.

Referring now to FIG. 3, a methodology 300 for automated human resource analytics and improvement may be implemented for a client organization using the system 100. The methodology 300 begins in block 302, in which the system 100 measures corporate culture of the client organization to generate the survey data 210. The system 100 may measure corporate culture by, for example, collecting the survey data 210 from employees using a web-based survey tool. In block 304, the system 100 evaluates the corporate culture of the client organization. The system 100 may evaluate the corporate culture by processing the survey data 210 and making that evaluation available to administrators of the client organization. Additionally, the system 100 may recommend one or more ideas for improving particular aspects of corporate culture of the client organization. The recommendation is performed by a data-driven recommendation engine that considers, among other things, the survey data 210, improvement idea data 212, results data 214, including results data 214 associated with other organizations, and the organizational data 216, including data such as geographic location, industry, size, revenue, and the like.

In block 306, the system 100 socializes the results of the survey data 210 and/or the recommended ideas for improvement. The system 100 may collect suggestions for improvement from employees, rank ideas for improvement based on feedback collected from employees, or otherwise generate ideas for improvement based on input from employees. In block 308, the system 100 implements one or more ideas to improve corporate culture. The system 100 may assist the client organization in implementation by providing detailed parameters or other information on recommended ideas, or by connecting the client organization with one or more partners. In block 310, the system 100 optimizes the recommendation engine based on results data 214. The system 100 may solicit feedback from employees concerning previous initiatives during the survey process of block 302, or otherwise collect information on the outcome of prior initiatives. The system 100 may record details of particular initiatives associated with the outcome of those initiatives. Thus, the data sources used by the recommendation engine may be continually improved. After completing block 310, the system 100 repeats the methodology 300, allowing the system 100 to continually measure and improve corporate culture.

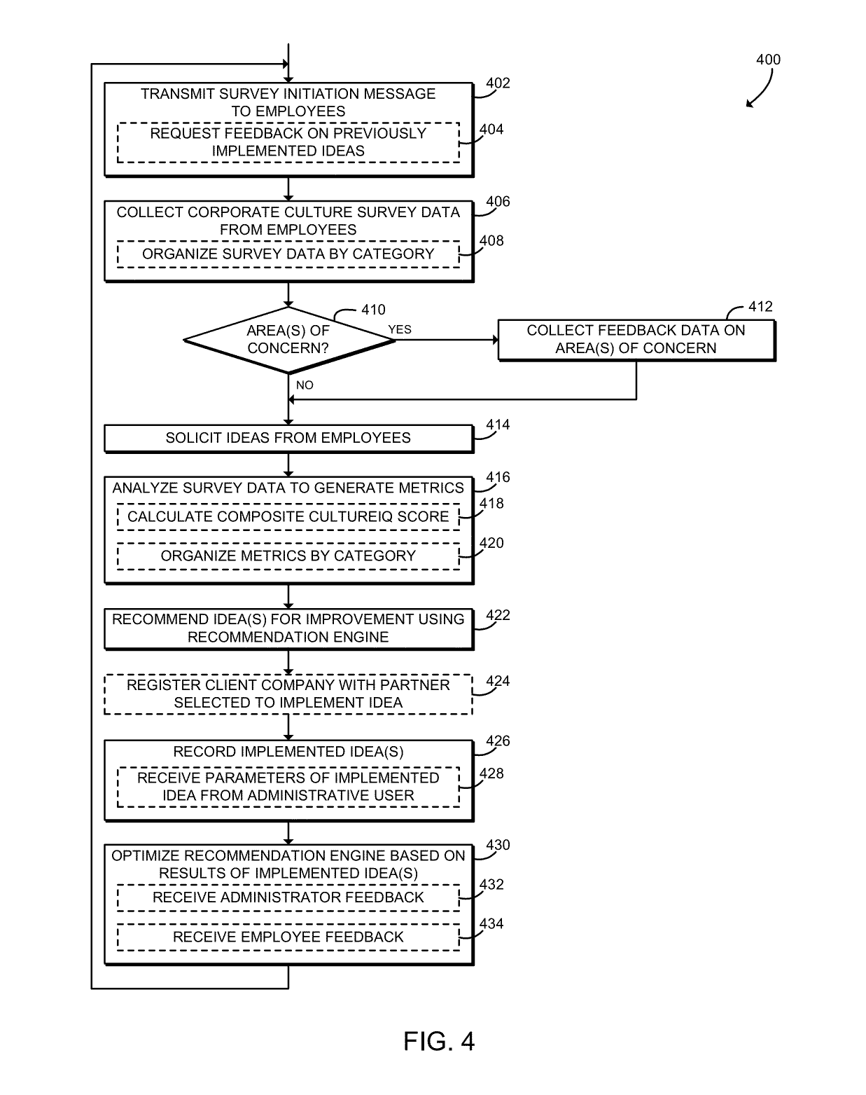

Referring now to FIG. 4, in use, the human resources server 102 may execute a method 400 for automated human resource analytics and improvement. The method 400 may be one embodiment of the methodology 300 described above in connection with FIG. 3. The method 400 begins with block 402, in which the human resources server 102 transmits a survey initiation message to one or more employees of the client organization. The survey initiation message may provide the employees with a hyperlink or other mechanism to complete the survey and provide survey data 210. The survey initiative message may include any other relevant information, including, for example, a notification that the survey is anonymous, an estimate of the time required to complete the survey, or other information. The human resources server 102 may use any method for transmitting the message; for example, the human resources server 102 may transmit an email message directed at identified employees. The employees may receive, view, and otherwise act on the message using any appropriate device, including an employee computing device 106. In some embodiments, in block 404 the human resources server 102 may request feedback on previously implemented ideas for improving company culture in the survey initiation message. The message may directly solicit feedback, for example, by including response fields for feedback, or may direct the employee to a web page or other mechanism for providing feedback.

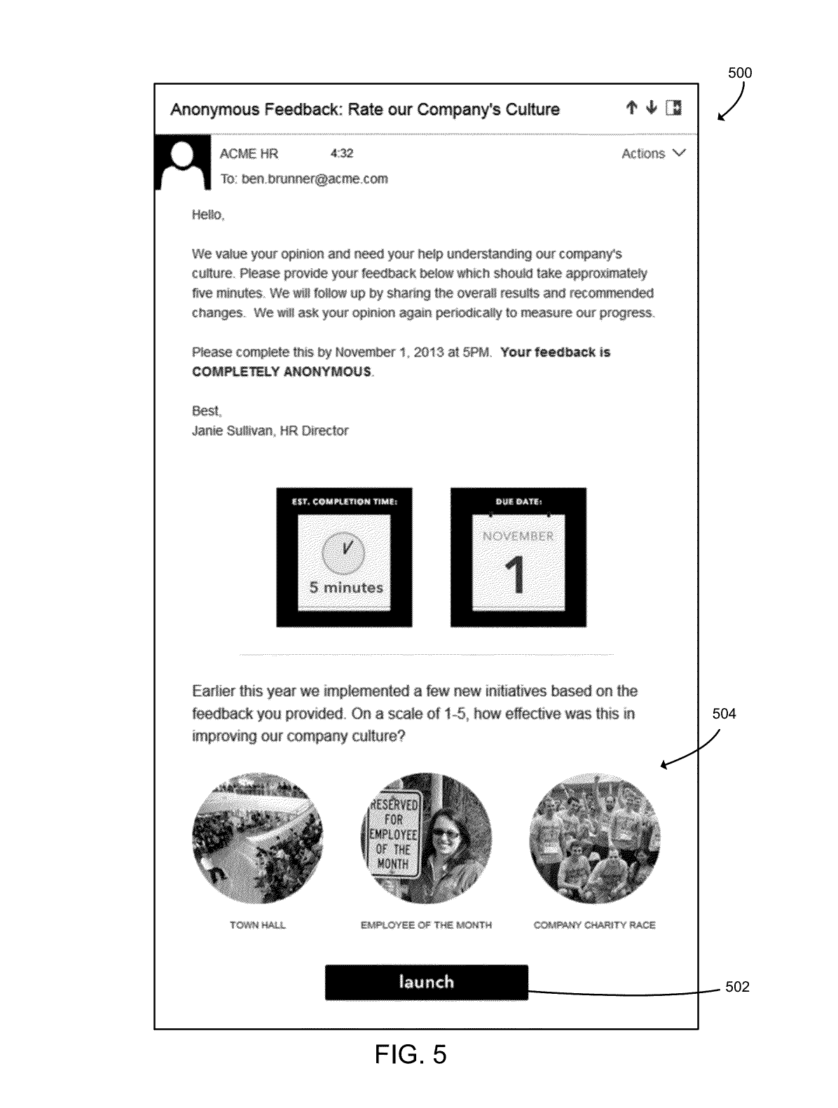

Referring now to FIG. 5, a sample initial transmission message 500 is shown. The illustrative initial transmission message 500 is an email message that may be displayed on an employee computing device 106. Additionally or alternatively, in some embodiments the initial transmission message may be a text message, personalized web page, or other communication. The illustrative transmission message 500 includes a launch button 502. When selected by the employee, the launch button 502 starts a web browser on the employee computing device 106 that in turn opens a connection to the human resources server 102 and starts the survey. The illustrative transmission message 500 further includes a feedback section 504. The feedback section 504 includes illustrated representations of several ideas for improvement that have been implemented by the client organization, also known as initiatives. The employee may provide feedback on those initiatives by selecting a representation, which may in turn start a web browser on the employee computing device 106 to provide feedback.

Referring back to FIG. 4, in block 406 the human resources server 102 collects corporate culture survey data 210 from the employees. The human resources server 102 may use any technique to collect the survey data 210. For example, the survey data 210 may be collected through a website provided by the human resources server 102, through a native application interfacing with the human resources server 102, through an application programming interface (API) of the human resources server 102, through a messaging interface of the human resources server 102, or through any other available technique.

The human resources server 102 may use any survey methodology to collect the survey data 210. For example, in some embodiments the human resources server 102 may ask the employees to select one or more images that best represent various aspects of the client organization or to indicate a degree of agreement with various statements about the client organization. In block 408, the human resources server 102 may organize the collected survey data 210 by category. The human resources server 102 may organize the survey data 210 as it is collected, for example, by grouping together questions relating to the same category, or may organize the survey data 210 after collection. The categories associated with the survey data 210 may or may not be visible to the employee during collection of the survey data 210.

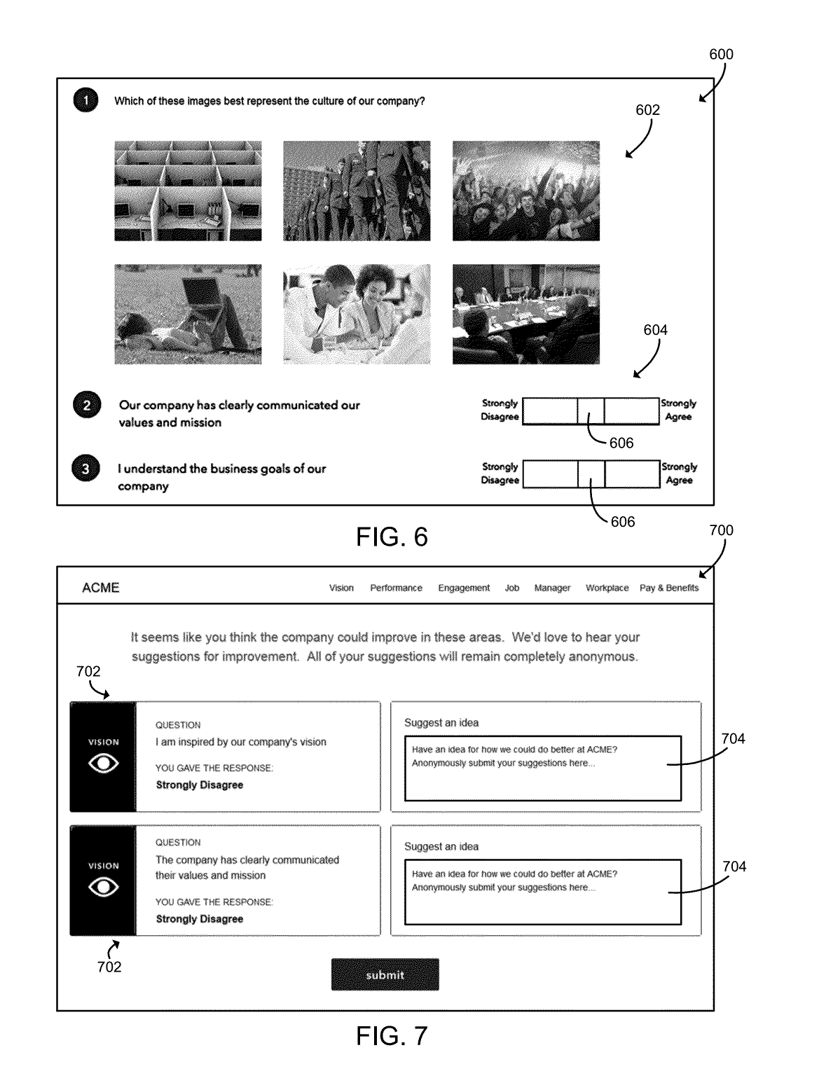

Referring now to FIG. 6, an illustrative survey data collection screen 600 is shown. The illustrative survey data collection screen 600 is a web page that may be displayed by an employee computing device 106. In other embodiments, the survey data collection screen 600 may be implemented as a database entry page, native application, or any other interface capable of providing data to the human resources server 102. The survey data collection screen 600 includes a visual question 602. As shown, the visual question 602 allows the employee to select one or more of the supplied images that best represent the culture of the client organization. Each of the supplied images may be selected to represent a particular aspect of corporate culture. Any number of images may be supplied. The survey data collection screen 600 also includes two ranking questions 604. The ranking questions 604 ask the employee to indicate the employee's level of agreement with a particular statement. In the illustrative example, each ranking question 604 includes a slider 606 that the employee may adjust to indicate the employee's level of agreement between strongly disagreeing and strongly agreeing. Additionally or alternatively, each ranking question 604 may include other modes of interaction such as radio buttons, combo boxes, or textual or numeric input fields.

Referring back to FIG. 4, in block 410 the human resources server 102 identifies whether any particular areas of concern exist based on the collected survey data 210. Areas of concern may include questions or categories for which the employee has provided strongly negative survey data 210 (e.g., the user has responded “strongly disagree” or “strongly agree,” depending on the sense of the question). If no areas of concern are identified, the method 400 advances to block 414, described below. If at least one area of concern is identified, the method 400 branches to block 412, in which the human resources server 102 collects feedback data on the identified area or areas of concern. For example, the human resources server 102 may request comments or present additional survey questions related to the area of concern.

Referring now to FIG. 7, an illustrative feedback screen 700 is shown. The feedback screen 700 is a web page that may be displayed by an employee computing device 106. In other embodiments, the feedback screen 700 may be implemented as a database entry page, native application, or any other interface capable of providing data to the human resources server 102. The feedback screen 700 includes two requests for feedback data 702. The requests for feedback data 702 identify the areas of concern by listing the associated survey question and employee response. Note also that each illustrative request for feedback data 702 identifies an associated category of survey data 210 (in the illustrative example, “Vision”). Each request for feedback data 702 includes a text input field 704 to collect suggestions from the employee.

Referring back to FIG. 4, in block 414 the human resources server 102 solicits ideas for improvement from employees. The human resources server 102 may allow employees to provide ideas for improvement at any time. For example, the human resources server 102 may solicit ideas for improvement while collecting survey data 210. Additionally or alternatively, the human resources server 102 may allow employees to submit ideas for improvement at other times, for example by visiting an appropriate web page for employee collaboration provided by the human resources server 102 using an employee computing device 106.

In block 416, the human resources server 102 analyzes the survey data 210 to generate metrics. After analysis, the collected survey data 210 and the generated metrics may be made available to the client organization, for example, by publishing the survey data 210 and generated metrics on an interactive website accessible by the administrator computing devices 104. In some embodiments, in block 418 the human resources server 102 calculates a composite culture score based on the survey data 210. The composite culture score may provide the client organization with an easy-to-understand measure of the corporate culture of the client organization. In some embodiments, in block 420 the human resources server 102 may organize the generated metrics by category. The categories may be the same categories used to organize the survey data 210, as described above in connection with block 408.

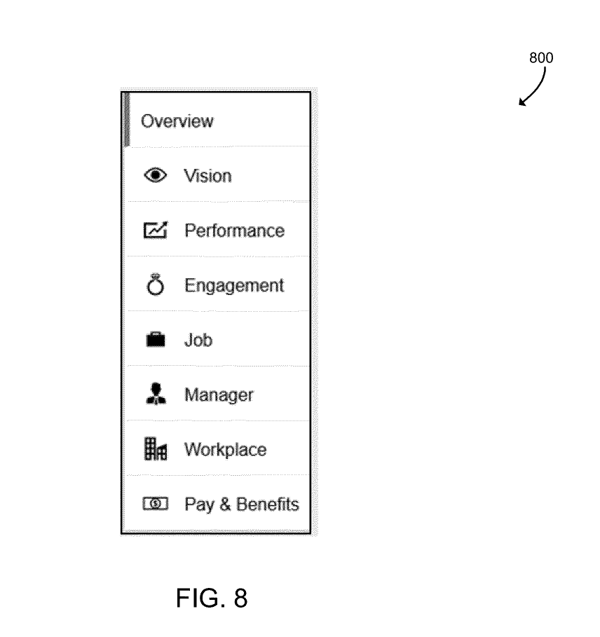

Referring now to FIG. 8, the listing 800 illustrates potential categories for generated metrics. The illustrative listing 800 is a navigation panel that may be displayed as part of a web page by an administrator computing device 104. The listing 800 may be used by an administrator to navigate a website providing analysis of the survey data 210. Additionally or alternatively, the listing 800 may be presented in any appropriate format, including without limitation a tabbed view, an icon view, a list view, or other organizational scheme. Further, the illustrative listing 800 includes an Overview item as well as seven categories (Vision, Performance, Engagement, Job, Manager, Workplace, and Pay & Benefits). However, other embodiments may include any number of categories and those categories may differ from the illustrative listing 800.

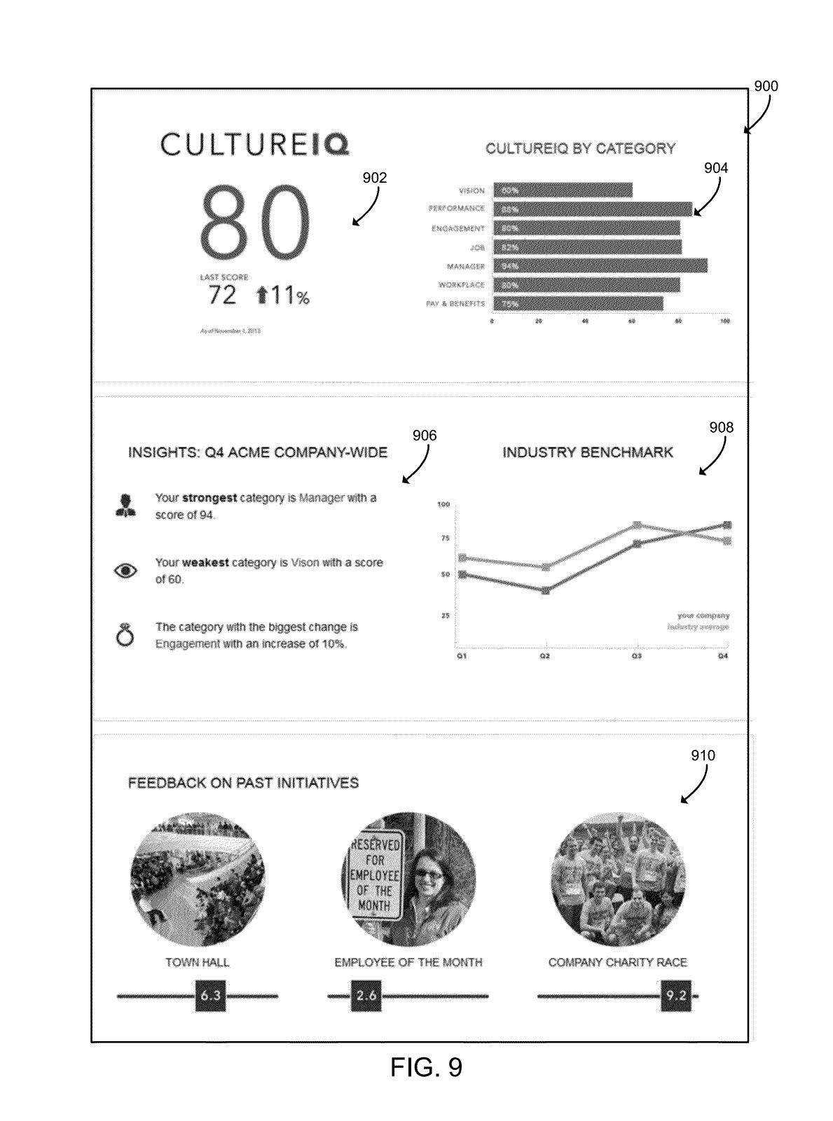

Referring now to FIG. 9, an illustrative analytics screen 900 is shown. The illustrative analytics screen 900 is at least part of a web page that may be displayed by an administrator computing device 104. The analytics screen 900 corresponds to an overview of all survey data 210 for the client organization. The analytics screen 900 includes a composite culture score 902, labeled as the CultureIQ. The analytics screen 900 also includes composite culture scores 904 that are organized by category. The illustrative analytics screen 900 further includes an insights panel 906 and an industry benchmark panel 908. The insights panel 906 and the industry benchmark panel 908 are based on analysis of collected survey data 210 and comparisons with survey data 210 from other organizations (which may also be client organizations). Other embodiments may include additional or different information analysis, and the particular information displayed may depend on the client organization. Last, the analytics screen 900 includes a feedback panel 910. The feedback panel 910 includes feedback information related to previous initiatives of the client organization. That feedback information may have been collected from employees during collection of the survey data 210, as described above in connection with block 404 of FIG. 4.

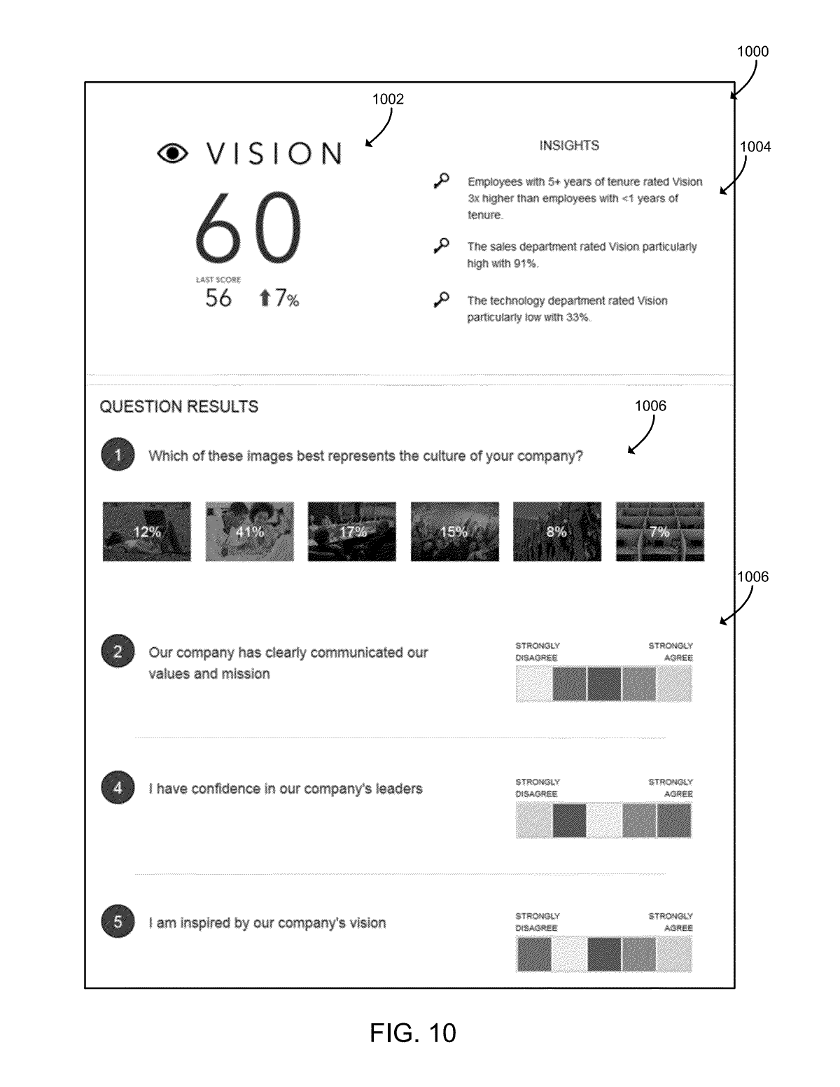

Referring now to FIG. 10, another illustrative analytics screen 1000 is shown. The illustrative analytics screen 1000 is at least part of a web page that may be displayed by an administrator computing device 104. The analytics screen 1000 is directed toward a particular category of the survey data 210 (in the illustrative example, “Vision”). The analytics screen 1000 includes a composite culture score 1002 and an insights panel 1004. Those elements are similar to the composite culture score 902 and the insights panel 906 described above in connection with FIG. 9. The analytics screen 1000 further includes a question results panel 1006. The question results panel 1006 includes summaries, scores, or metrics relating to the collected survey data 210. As shown, the question results panel 1006 includes response percentages for image-based survey questions and color-coded graphs for level of agreement questions. Of course, results may be presented in other formats, including textual, numerical, or tabular results.

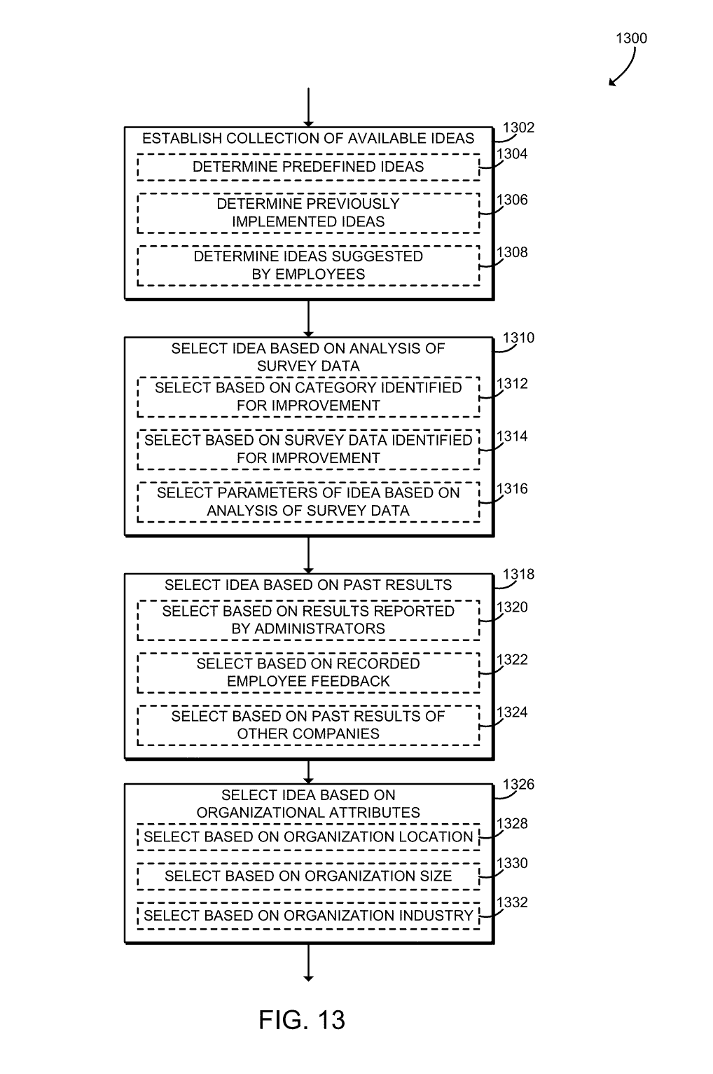

Referring back to FIG. 4, after analyzing the survey data 210, in block 422 the human resources server 102 recommends one or more ideas for improving corporate culture of the client organization using a recommendation engine. Ideas for improvement may include particular activities, programs, policies, or other initiatives that may be implemented by the client organization to improve one or more aspects of corporate culture. Accordingly, the human resources server 102 may select the recommended idea to address one or more areas of corporate culture that could be improved, based on the collected survey data 210. The human resources server 102 may also recommend particular attributes of the recommended ideas. The recommended ideas may be selected from the improvement idea data 212, which may include a number of predefined ideas, a collection of initiatives previously implemented by the client organization or other organizations, or ideas suggested by employees. The human resources server 102 may present the recommended ideas to the client organization, for example, through a website accessible by the administrator computing devices 104. The selection and recommendation of ideas for improvement is described further below, in connection with FIG. 13.

In some embodiments, in block 424, the human resources server 102 may register the client organization with a partner organization selected to implement one or more of the recommended ideas. The partner organization may be any organization with a business or technical relationship with the system 100. For example, the partner organization may be a vendor, service provider, consultant, or any other entity capable of assisting the client organization with implementing a recommended idea. To register the client organization, the human resources server 102 may facilitate registering the client organization with a partner computing device 108 that is controlled by or otherwise interfaced with the partner organization. For example, in some embodiments, the human resources server 102 may provide one or more hyperlinks to connect the client organization with the partner computing device 108. Additionally or alternatively, the human resources server 102 may place an order directly with the partner computing device 108, transmit a message to the partner computing device 108, or otherwise communicate with the partner computing device.

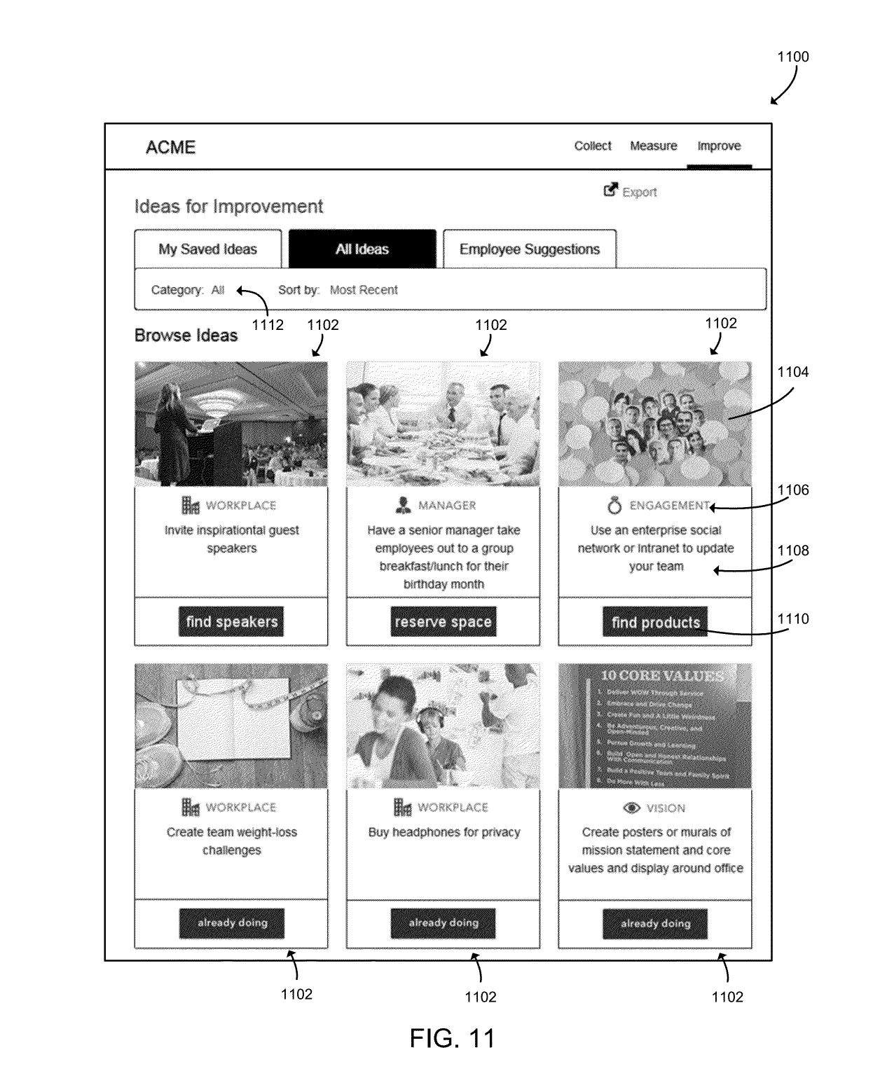

Referring now to FIG. 11, an illustrative recommended ideas screen 1100 is shown. The illustrative recommended ideas screen 1100 is at least part of a web page that may be displayed by an administrator computing device 104. The illustrative recommended ideas screen 1100 includes six recommended ideas 1102. Each recommended idea 1102 includes a visual representation 1104, a category label 1106, and a description 1108. Each recommended idea 1102 may be selected or otherwise activated by the administrator to identify additional details regarding the recommendation, including recommended parameters. For example, additional details may include example policies, template materials, schedules, or other parameters useable to implement the idea. Although the illustrative recommended ideas screen 1100 includes six recommended ideas 1102, it should be understood that in some embodiments many more recommended ideas 1102 may be provided.

Each recommended idea 1102 further includes an action button 1110. Selection of the action button 1110 may cause the human resources server 102 to register the client organization with one or more partner organizations, as described above in connection with block 424. For example, the action button 1110 labeled “find speakers” may allow the client organization to identify or otherwise connect with persons or organizations that provide motivational speakers. As another example, the action button 1110 labeled “reserve space” may allow the client organization to identify or connect with one or more venues for holding a group lunch. As a third example, the action button 1110 labeled “find products” may allow the client organization to identify vendors, identify vendors, or purchase products to provide an enterprise social network. The action buttons 1110 labeled “already doing” may allow the administrator to identify ideas that are being or have already been implemented by the client organization. Last, the illustrative recommended ideas screen 1100 includes a category selector 1112 that allows an administrator to organize or restrict the recommended ideas by category.

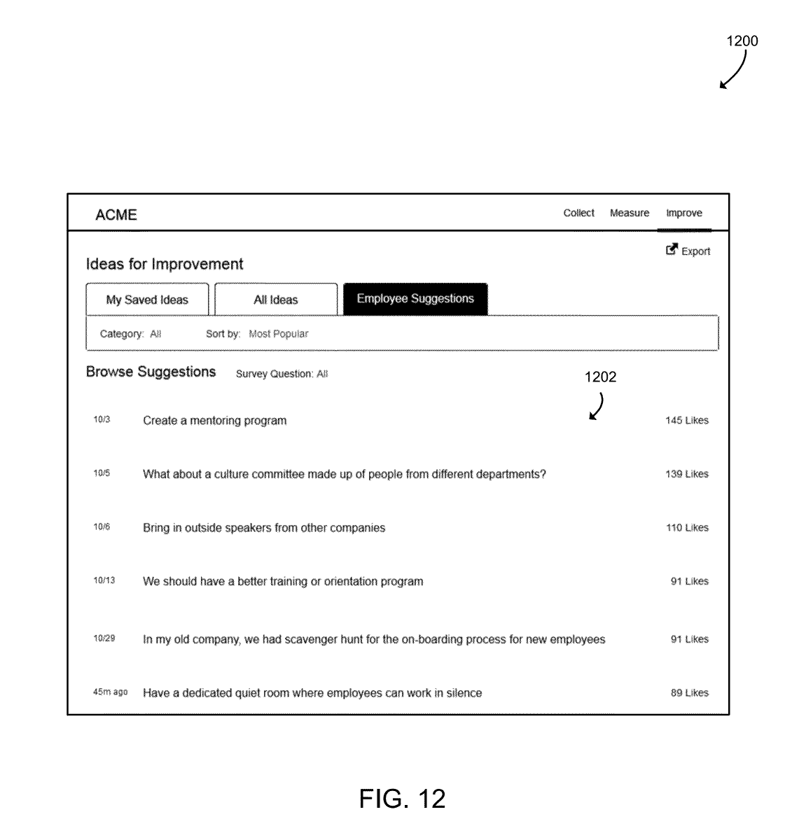

Referring now to FIG. 12, another illustrative recommended ideas screen 1200 is shown. The illustrative recommended ideas screen 1200 is at least part of a web page that may be displayed by an administrator computing device 104. The recommended ideas screen 1200 includes a number of recommended ideas 1202 that have been received from employees. The recommended ideas 1202 further include a social metric, which in the illustrative example is the number times a recommended idea 1202 has been “liked” by employees. The client organization may use the social metric to determine the recommended ideas 1202 that are preferred by employees. The human resources server 102 may receive feedback from employees concerning suggested ideas at any time, including during collection of the survey data 210 or otherwise through an employee collaboration or social networking interface to the human resources server 102.

Referring back to FIG. 4, in block 426, the human resources server 102 records any ideas implemented by the client organization, including the parameters of implemented ideas. The human resources server 102 may use any method for identifying implemented ideas and their parameters. For example, when the client organization implements an idea with a partner organization through the human resources server 102, the human resources server 102 may directly record the selected idea or receive details of the selected idea from the partner organization. In some embodiments, in block 428 the human resources server 102 may receive parameters of an implemented idea from an administrative user. In some embodiments, the human resources server 102 may use predefined or default parameters associated with a particular idea selected by the administrative user. Additionally or alternatively, in some embodiments the administrative user may enter parameters into the human resources server 102, for example using a web browser of the administrator computing device 104. For example, referring again to FIG. 11, after the administrator selects an action button 1110 labeled “already doing,” the human resources server 102 may prompt the administrator for parameters of the idea as it is implemented. Implemented ideas and their parameters may be stored in the improvement idea data 212, allowing those ideas to be recommended in the future.

In block 430, the human resources server 102 optimizes the recommendation engine based on results data 214 associated with any implemented idea or ideas. The human resources server 102 may optimize the recommendation engine to select ideas from the improvement idea data 212 that are associated with better outcomes in the results data 214. By optimizing the recommendation engine, the human resources server 102 may provide improved data-driven recommendations for the client organization or other client organizations. In some embodiments, in block 432 the human resources server 102 may receive administrator feedback concerning implemented ideas. The administrator feedback may include quantitative data regarding the client organization, as well as qualitative data on corporate culture. In some embodiments, in block 434 the human resources server 102 may receive employee feedback. The employee feedback may include feedback on implemented ideas that is solicited as described above in connection with block 404. The employee feedback may also include survey data 210 that reflects the effects of implemented ideas on corporate culture. After optimizing the recommendation engine, the method 400 loops back to block 402 to continue measuring and improving corporate culture.

Referring now to FIG. 13, the human resources server 102 may execute a method 1300 for recommending an idea for improvement. The method 1300 may be executed, for example, in connection with block 422 of FIG. 4, described above. The method 1300 begins with block 1302, in which the human resources server 102 establishes a collection of available ideas for improvement that may be selected. The available ideas may include any ideas stored in or referenced by the improvement idea data 212. In some embodiments, in block 1304 the human resources server 102 may define a collection of predefined ideas. Those predefined ideas may be defined by any source, including the client organization, system vendors, or domain experts such as human resource consultants. In some embodiments, in block 1306 the human resources server 102 may define a collection of previously implemented ideas or initiatives. Those ideas may have been previously implemented by the client organization or by other organizations. In some embodiments, in block 1308 the human resources server 102 may define a collection of ideas suggested by employees. Similar to previously implemented ideas, the suggested ideas may have been suggested by employees of the client organization or by employees of other organizations.

In block 1310, the human resources server 102 selects one or more ideas based on the analysis of the survey data 210. The human resources server 102 may select an idea for improvement based on any identified pattern, trend, or other data analysis of the survey data 210. The human resources server 102 may select the idea for improvement by narrowing, restricting, searching, or otherwise processing ideas in the improvement idea data 212. In block 1312, in some embodiments the human resources server 102 may select an idea based on a category identified for improvement in the survey data 210. For example, the survey data 210 may indicate that the client organization has low “Vision” scores. In that example, the human resources server 102 may select an idea for improvement targeted toward the Vision category. In some embodiments, in block 1314 the human resources server 102 may select an idea for improvement based on particular items of the survey data 210 identified for improvement. For example, the human resources server 102 may select an idea for improvement based on responses to a particular question in the survey data 210. In block 1316, in some embodiments, the human resources server 102 may select parameters of one or more ideas based on the analysis of the survey data 210. For example, consider that the human resources server 102 selected an idea to “hold a town hall meeting” based on the survey data 210. In addition to selecting the idea, the human resources server 102 may select parameters of the suggested idea, for example, a recommended date, time, and/or format of the town hall meeting based on the survey data 210.

In block 1318, the human resources server 102 selects one or more ideas based on results data 214 associated with previously implemented ideas. In particular, the human resources server 102 may select one or more ideas that, after being implemented, have shown improved outcomes in similar circumstances. In some embodiments, in block 1320 the human resources server 102 may select the one or more idea based on results data 214 reported by administrators of the client organization. That results data 214 may be received as part of an administrator feedback process described above in connection with block 430 of FIG. 4. In some embodiments, in block 1322, the human resources server 102 may select the one or more idea based on results data 214 reported by employees of the client organization. That results data 214 may be received as part of an employee feedback process described above in connection with block 404 of FIG. 4. In some embodiments, in block 1324 the human resources server 102 may select the one or more ideas based on results data 214 associated with organizations other than the client organization. Those results may have been reported by administrators or employees of the other organizations, similar to as described above. In those embodiments, the survey data 210, the improvement idea data 212, and the results data 214 may be available to other organizations in at least aggregated form.

In block 1326, the human resources server 102 selects one or more ideas for improvement based on attributes of the client organization. The human resources server 102 may select ideas that have shown positive outcomes for similar organizations in the past. The human resources server 102 may select ideas based on any attributes or combination of attributes of the client organization. The attributes of the client organization may be stored in and/or referenced by the organizational data 216. In some embodiments, in block 1328, the human resources server 102 may select ideas based on geographic location of the client organization. In some embodiments, in block 1330, the human resources server 102 may select ideas based on size of the client organization, for example, measured by the number of employees, revenue, or other measure. In some embodiments, in block 1332, the human resources server 102 may select ideas based on the industry, sector, field, or other categorization of the client organization. A selection may be based on some or all attributes of the client organization. For example, the human resources server 102 may select ideas that have shown positive results for organizations that (i) are located in the northeastern United States, (ii) have between 50-100 employees, and (iii) are in the manufacturing industry. After selecting based on company attributes, the method 1300 is completed. The finally selected idea or ideas may be suggested to the client organization as described above in connection with FIG. 4.

Although the methods 400, 1300 have been illustrated as executing sequentially, it should be understood that the functions of those methods may be executed in any order, including in parallel, concurrently, or contemporaneously. For example, those functions may be made available as web pages, APIs, data tables, or other components of the human resources server 102 that may be activated or accessed at any time. Additionally or alternatively, the human resources server 102 may allow access by numerous client organizations, all of which may activate or access different functions of the methods 400, 1300 contemporaneously.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

In summary, the technologies described above allow a client organization to measure and evaluate corporate culture using an automated employee survey system. Additionally, the client organization may review a number of suggested initiatives to improve corporate culture, automatically generated based on measured culture data. The client organization may collect collaborative input from employees on those suggested initiatives. Additionally, the described technologies may assist the client organization in implementing suggested initiatives as well as automatically collecting feedback on implemented initiatives. Based on collected feedback, the recommendation engine may be continually optimized to improve the recommended initiatives. Similarly, data collected from many client organizations may be used to optimize the recommendation engine.

1. A human resources server for corporate culture improvement, the human resources server comprising:
a survey module to collect corporate culture survey data from one or more employee computing devices;
an analytics module to analyze the survey data;
a recommendation engine module to recommend an initiative to improve corporate culture as a function of the survey data using a recommendation engine of the human resources server; and
an implementation module to (i) receive results data associated with the recommended initiative and (ii) optimize the recommendation engine as a function of the results data.

2. The human resources server of claim 1, wherein:
the survey module is further to (i) transmit an invitation to provide survey data to one or more employees and (ii) request the results data associated with the recommended initiative in the invitation to provide survey data;
wherein to receive the results data comprises to receive the results data from the employee computing device in response to transmission of the invitation.

3. The human resources server of claim 1, wherein the survey module is further to receive the initiative from an employee computing device.

4. The human resources server of claim 1, wherein to analyze the survey data comprises to generate a composite culture score as a function of the survey data.

5. The human resources server of claim 4, wherein to generate the composite culture score comprises to generate a composite culture score as a function of a category of the survey data.

6. The human resources server of claim 1, wherein the implementation module is further to:
receive one or more parameters associated with the recommended initiative; and
associate the results data with the one or more parameters.

7. The human resources server of claim 1, wherein the implementation module is further to register a client organization associated with the survey data with a partner organization to implement the recommended initiative.

8. The human resources server of claim 1, wherein:
to collect the survey data comprises to collect the survey data associated with a first client organization;
to receive the results data comprises to receive the results data associated with the recommended initiative from a second client organization; and
to recommend the initiative comprises to recommend the initiative as a function of the results data received from the second client organization.

9. The human resources server of claim 8, wherein:
the survey module is further to (i) collect first organization data associated with the first client organization and (ii) collect second organization data associated with the second client organization; and
to recommend the initiative comprises to recommend the initiative as a function of the first organization data and the second organization data.

10. The human resources server of claim 9, wherein an attribute of the first organization data matches the attribute of the second organization data, the attribute being one of geographical location, organization size, organization field, or organization industry.

11. A method for corporate culture improvement, the method comprising:
collecting, by a human resources server, corporate culture survey data from one or more employee computing devices;
analyzing, by the human resources server, the survey data;
recommending, by the human resources server, an initiative to improve corporate culture as a function of the survey data using a recommendation engine of the human resources server;
receiving, by the human resources server, results data associated with the recommended initiative; and
optimizing, by the human resources server, the recommendation engine as a function of the results data.

12. The method of claim 11, further comprising:
receiving, by the human resources server, one or more parameters associated with the recommended initiative; and
associating, by the human resources server, the results data with the one or more parameters.

13. The method of claim 11, further comprising registering, by the human resources server, a client organization associated with the survey data with a partner organization to implement the recommended initiative.

14. The method of claim 11, wherein:
collecting the survey data comprises collecting the survey data associated with a first client organization;
receiving the results data comprises receiving the results data associated with the recommended initiative from a second client organization; and
recommending the initiative comprises recommending the initiative as a function of the results data received from the second client organization.

15. The method of claim 14, further comprising:
collecting, by the human resources server, first organization data associated with the first client organization; and
collecting, by the human resources server, second organization data associated with the second client organization;
wherein recommending the initiative comprises recommending the initiative as a function of the first organization data and the second organization data, wherein an attribute of the first organization data matches the attribute of the second organization data, the attribute being one of geographical location, organization size, organization field, or organization industry.

16. One or more computer-readable storage media comprising a plurality of instructions that in response to being executed cause a human resources server to:
collect corporate culture survey data from one or more employee computing devices;
analyze the survey data;
recommend an initiative to improve corporate culture as a function of the survey data using a recommendation engine of the human resources server;
receive results data associated with the recommended initiative; and
optimize the recommendation engine as a function of the results data.

17. The one or more computer-readable storage media of claim 16, further comprising a plurality of instructions that in response to being executed cause the human resources server to:
receive one or more parameters associated with the recommended initiative; and
associate the results data with the one or more parameters.

18. The one or more computer-readable storage media of claim 16, further comprising a plurality of instructions that in response to being executed cause the human resources server to register a client organization associated with the survey data with a partner organization to implement the recommended initiative.

19. The one or more computer-readable storage media of claim 16, wherein:
to collect the survey data comprises to collect the survey data associated with a first client organization;
to receive the results data comprises to receive the results data associated with the recommended initiative from a second client organization; and
to recommend the initiative comprises to recommend the initiative as a function of the results data received from the second client organization.

20. The one or more computer-readable storage media of claim 19, further comprising a plurality of instructions that in response to being executed cause the human resources server to:
collect first organization data associated with the first client organization; and
collect second organization data associated with the second client organization;
wherein to recommend the initiative comprises to recommend the initiative as a function of the first organization data and the second organization data, wherein an attribute of the first organization data matches the attribute of the second organization data, the attribute being one of geographical location, organization size, organization field, or organization industry.
